(19) United States
(12) Patent Application Publication
(10) Pub. No.: US 2014/0215100 A1
(43) Pub. Date: Jul. 31, 2014

(54) SYSTEM FOR MANAGING DOMESTIC PERIPHERALS

(71) Applicants: Nicolas Janicaud, Vanves (FR); Francois Bodet, Morsang sur Orge (FR)

(72) Inventors: Nicolas Janicaud, Vanves (FR); Francois Bodet, Morsang sur Orge (FR)

(21) Appl. No.: 14/241,069

(22) PCT Filed: Aug. 27, 2012
(86) PCT No.: PCT/EP2012/066623

§ 371 Date: Feb. 25, 2014

(30) Foreign Application Priority Data
Aug. 26, 2011 (FR) 1157545

(51) Int. Cl. G06F 13/10

(52) U.S. Cl. CPC G06F 13/10
USPC 710/16

(57) ABSTRACT

The present invention relates to a system for managing a plurality of peripherals (1), each peripheral (1) being connected to an Internet access box (2) and each Internet access box (2) being linked to the Internet (30) via an operator network (20), characterized in that it comprises a peripherals management equipment (4) disposed within the operator network (20), a list of virtual objects (1′) being stored on the peripherals management equipment (4), each virtual object (1′) representing in a unique manner a peripheral (1). The present invention also relates to methods of installing, remotely controlling and monitoring at least one peripheral (1).

### GENERAL TECHNICAL FIELD

The present invention relates to the field of home automation.

More specifically, it relates to a system for managing a plurality of domestic peripherals.

### STATE OF THE ART

At the dawn of the digital age, more and more [symbol] smart [symbol] objects connectible to Internet are available, these objects ranging from game consoles to domestic electrical appliances including radiators, alarms or further rolling shutters.

Home automation, which is the whole of the techniques allowing control and automation (i.e. a use requiring increasingly less human intervention) of these objects in a dwelling, is being extensively transformed.

Up to now, the diversity of the objects, brands and communication protocols has resulted in that the control of different pieces of equipment in the home posed compatibility problems and required a plurality of casings and other diverse connectors, unless their installation was anticipated right from the construction of the building. The scenarii implying that more than a handful of pieces of equipment communicate with each other, remain quasi-impossible.

International patent application WO 2009/049325 proposes integration of pieces of equipment of a domestic network around a [symbol] service node [symbol] , which may be a device for accessing Internet (Integrated Access Device, IAD, commonly called a [symbol] box [symbol] ). It is noted that the pieces of equipment have to be capable of running an [symbol] agent [symbol] installed by the service node on the one hand, and that a [symbol] home client [symbol] for example installed on a computer has to be present for controlling the whole on the other hand.

This system in spite of everything remains limited and requires quite consequent intervention of the user. Therefore it is not within the reach of laymen.

Therefore it would be desirable to have a novel system for managing domestic equipment (or [symbol] peripherals [symbol] ) which allows the integration of any piece of equipment in a totally transparent way for the user, and which provides a wide variety of services both for the monitoring of equipment and for their automation and their remote control in complex scenarii.

### PRESENTATION OF THE INVENTION

According to a first aspect, the present invention therefore relates to a system for managing a plurality of peripherals, each peripheral being connected to an Internet access device and each Internet access device being connected to the Internet via an operator network, characterized in that it comprises a peripherals managing equipment arranged within the operator network, a list of virtual objects being stored on the peripherals managing equipment, each virtual object representing in a unique manner a peripheral.

According to other advantageous and non-limiting features:

each virtual object consists in a set of computer data comprising:

a unique identifier of the peripheral, through which the virtual object is referenced on the peripherals managing equipment,

at least one attribute of the peripheral, each attribute identifying a controllable element of the peripheral;

the set of computer data of each virtual object further comprises an address, notably the MAC address, of the Internet access device to which the peripheral represented by the virtual object is connected;

at least one peripheral is connected to the Internet access device via a dongle;

at least one peripheral is directly connected to the Internet access device via an Internet, a USB or Wifi connection;

each Internet access device records the uses of the peripherals which are connected to it, the recordings being transmitted regularly to the peripherals managing equipment;

at least one peripheral comprises a sensor for measuring a physical quantity, said recordings of the use of the peripheral comprising the values of the physical quantity measured by said sensor;

the whole of the computer data of each virtual object further comprises the recordings relating to the peripherals transmitted to the peripherals managing equipment.

According to a second aspect, the invention relates to a method for setting up a peripheral in the system according to the first aspect of the invention, characterized in that during the first connection of the peripheral to an Internet access device, steps are applied for:
identifying the type of peripheral,
downloading onto the Internet access device a driver associated with the type of peripheral, said driver allowing communication of data between the Internet access device and the peripheral,
creating on the peripherals managing equipment a virtual object representing in a unique manner the peripheral.

According to other advantageous and non-limiting features:

the step for identifying the type of the peripheral comprises the qualification of physical operating characteristics of said peripheral and the assigning to the peripheral of a unique identifier depending on said physical characteristics;

said driver associated with the type of peripheral is the driver referenced by a unique identifier assigned to the peripheral in a database of drivers stored on the peripherals managing equipment.

According to a third aspect, the invention relates to a method for remotely controlling via a terminal connected to the Internet at least one peripheral in a system according to the first aspect of the invention, characterized in that it comprises steps for:
sending from the terminal a request to the peripherals managing equipment, said request designating at least one peripheral;
consulting with the peripherals managing equipment at least one virtual object representing said at least one peripheral;
transmitting the request to at least one Internet access device, the address of which is associated with said at least one determined virtual object;
transmitting the request to said at least one peripheral through said at least one Internet access device.

According to a fourth aspect, the invention relates to a method for monitoring at least one peripheral in a system according to the first aspect of the invention, a terminal being connected to the Internet characterized in that it comprises steps for:
sending from the terminal a request to the peripherals managing equipment, said request designating one or several peripherals;
consulting with the peripherals managing equipment at least one virtual object representing at least one said peripheral;
transmitting to the terminal at least one recording associated with at least one virtual object.

### PRESENTATION OF THE FIGURES

Other features and advantages of the present invention will become apparent upon reading the description which follows of a preferential embodiment. This description will be given with reference to the appended drawings wherein:

FIG. 1 is a diagram of the system according to the invention;

FIG. 2 is a diagram representing in detail the connections between an Internet access device and a plurality of peripherals.

### DETAILED DESCRIPTION

### Structure of the System

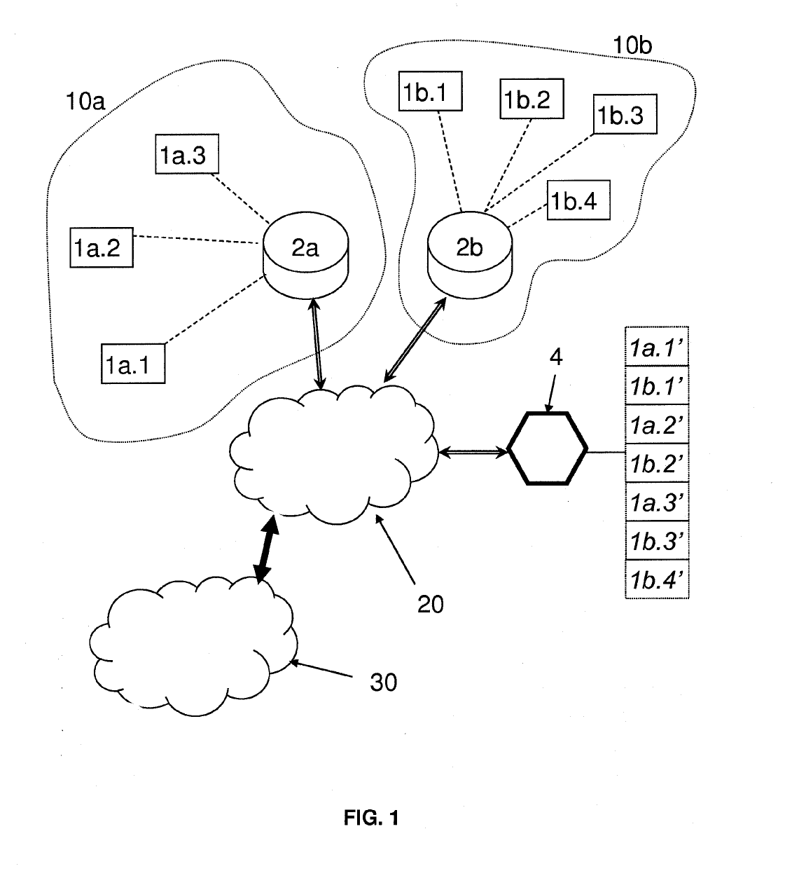

With reference to the drawings and notably to FIG. 1, the invention relates to a system for managing a plurality of peripherals 1. As explained earlier, by the term of peripheral is meant any connectible domestic object, whether these objects are complex, for example television sets or cameras, or very simple, in particular, switches. The term of peripheral also covers any sensor of a physical quantity which may be directly found in the home or integrated into an object, for example a temperature sensor.

Each peripheral 1 is connected to an Internet access device 2 (the [symbol] box [symbol] , called an IAD, as explained above) and each Internet access device 2 is connected to the Internet 30 via an operator network 20, often called a [symbol] backbone [symbol] . In FIG. 1, the spaces 10a and 10b represent two [symbol] houses [symbol] , each respectively having its box 2a, 2b and its peripherals 1a.X, 1b.X (by house, is meant any sort of home having a box 2).

It should be noted that the term of [symbol] Internet access device [symbol] is not limited to boxes and may for example comprise portable telephones having Internet connectivity.

Moreover it will be noted that it is not mandatory that the Internet access device 2 consist of a single physical entity. Indeed, in the case of a box, it is for example possible to separate the modem (i.e. the portion which allows conversion of a digital signal into an analog signal for ADSL, in other words the first ISO layer) from the remainder of the Internet access device 2 (i.e. the ISO layers other than the first, the high level QoS of the services (VOIP, LAN . . . ) or further the connections), both entities for example being connected via an Ethernet cable, Wifi or CPL casings.

It will thus be understood that the term of [symbol] Internet access device [symbol] encompasses both entities, and any peripheral 1 connected to either one will be considered in the present description as connected to an Internet access device 2. This connection between the Internet access device 2 and the peripherals 1 may be achieved in diverse ways and mainly depends on the physical connectivity which is available to each peripheral 1. In particular a peripheral 1 may be directly connected to the Internet access device 2 if it has connectivity natively present on the Internet access device 2 (for example an Ethernet, USB, HDMI or Wifi connection).

In the absence of direct connectivity, it is possible to use a material extension providing the missing physical connectivity. This extension, commonly called a [symbol] dongle [symbol] 3 (or key connector) is connected on one of the ports of the Internet access device 2 (for example an USB port). Mention may be made for example of a dongle 3, a key with an IrDA (infrared) port: it provides the Internet access device 2 with connection to any peripheral 1 which would have such connectivity via infrared radiations, for example a remote control. A single dongle 3 is indeed most often sufficient per type of connectivity. It is noted that a dongle 3 most often provides wire connectivity (it then consists in a simple adaptor), but it may be, like in the case of the IrDA key, a transceiver of wireless connectivity. By means of the dongle 3, it is possible to manage in a single environment objects from different manufacturers which are very likely to have different connectivity.

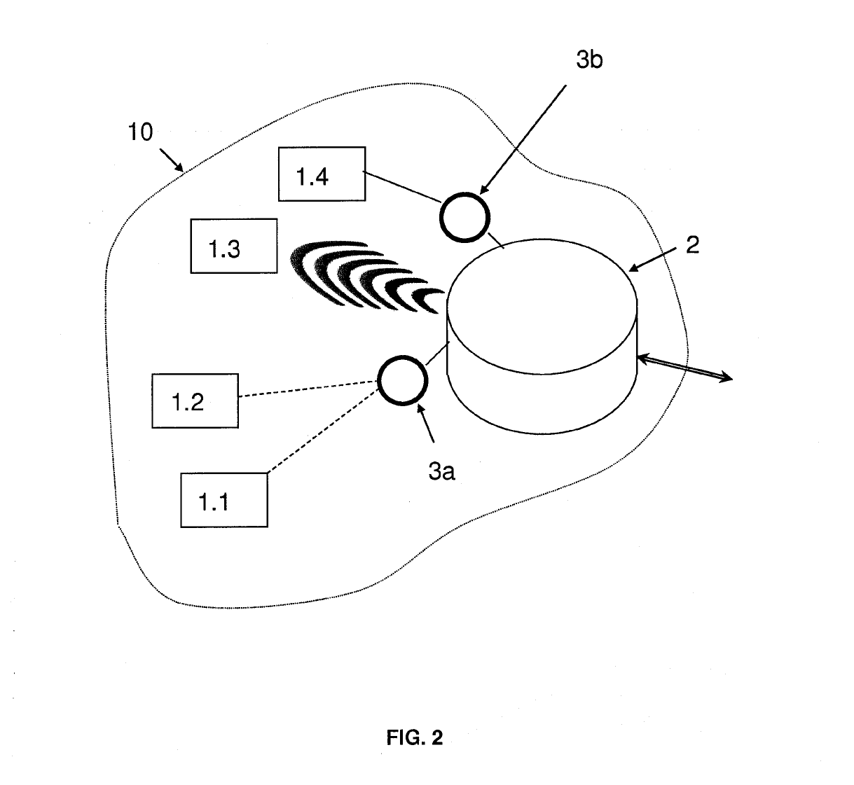

A 3G key may be used as a quite particular dongle 3. Indeed a peripheral 1 having 3G connectivity is already capable of connecting to the Internet without passing through a box 2. The 3G key may therefore be used not for providing connectivity, but with the purpose of exploring functionalities which may be provided by peripheral 1 having 3G connectivity in the house 10. One of these functionalities may for example be the possibility of sending SMSes, optionally via the box 2. Thus, it is possible to imagine as a peripheral 1, an alert device which elderly persons may wear around the neck, and when the button is pressed, in addition to the emergency alert, the system according to the invention would trigger the sending of SMSes to prerecorded numbers. FIG. 2 illustrates exemplary connection architecture of the peripherals 1 within a house 10. It is seen that there are four peripherals 1.1, 1.2, 1.3 and 1.4. The peripheral 1.3 is directly connected to the device 2 via Wifi, while the other ones are connected via two dongles 3. Here the peripherals 1.1 and 1.2 share the same connectivity and may therefore be connected to the Internet access device 2 via the same dongle 3a, while the peripheral 1.4, having different physical connectivities, has to pass through the dongle 3b.

The system according to the invention is distinguished in that it comprises, as seen in FIG. 1, a peripherals managing equipment 4 positioned on the operator network 20.

This peripherals managing equipment 4 is in particular a server having spaces for storing data and processing means. A list of virtual objects 1′ is actually stored on the peripherals managing equipment 4, each virtual object 1′ representing in a unique manner (exclusively) a peripheral 1. The idea is to expose in the fashion of a bus, all the peripherals 1 of all the Internet access devices 2 without any topological distinction. Thus, as seen in FIG. 1, the seven peripherals 1 of the illustrated system have their virtual object 1′ at the peripherals managing equipment 4.

The fact that it is positioned on the operator network 20 and not directly connected to Internet 30 increases the security of the data which it will receive: the operator network 20 would first have to be penetrated in order to be able to hack it.

### Notion of a Virtual Object

Each virtual object 1′ consists in a set of computer data which allow description of the represented peripheral.

A virtual object 1′ may thus advantageously comprise all or part of the following data:
a unique identifier of the peripheral 1 (or [symbol] UID [symbol] ), through which the virtual object 1′ is referenced on the peripherals managing equipment 4. This is for example a numerical or alphanumerical code, one portion of which may identify the type of peripheral (see later on);
at least one attribute of the peripheral 1. Each attribute identifies an operating parameter of the peripheral 1, and may indicate its condition. For example, if the peripheral 1 is a lamp, the attribute may be [symbol] ON [symbol] or [symbol] OFF [symbol] . If the peripheral 1 is a rolling shutter, this may be a value corresponding to the unwound shutter length. A peripheral 1 may have many attributes, in particular if it is complex.
an address, notably the MAC address or the IP address, of the Internet access device 2 to which the peripheral 1 represented by the virtual object 1′ is connected. This allows the peripheral 1 to be localized, and to know at any moment which path is the connection path.
recordings concerning the peripheral 1 transmitted to the peripherals managing equipment 4, indeed, each Internet access device 2 advantageously records the uses of the peripherals 1 connected to it, the recordings being transmitted regularly to the peripherals managing equipment 4. These recordings of uses, or [symbol] logs [symbol] make a list of the whole of the information relating to the use of the peripheral 1, whether control is a remote control or direct control by the user. For example, in the case of the lamp, the recording of use may list the time intervals during which the lamp is on. Further, the peripheral 1 may comprise a sensor for measuring a physical quantity, said recordings of use of the peripheral then comprise the values of the physical quantity measured by said sensor. It is quite possible to combine recordings of use and recordings of physical quantities. For example, if the peripheral 1 is a radiator, the recordings may comprise the intervals during which the radiator has produced heat and at which levels (uses) as well as the temperature measured at regular intervals by an internal sensor (physical quantity) if there is one. It is noted that the physical quantity may simply be the electric consumption of the peripheral 1. The benefits of such recordings will be described subsequently.

### Example of a Virtual Object

Let us take the case of the radiator as a peripheral 1. The associated virtual object 1′ may be:

| UID | MAC IAD | Attribute 1 | recordings |
|---|---|---|---|
| AA0001 | 5E:FF:56:A2:AF:15 | Heating = off | Operation logs |
| | | | Consumption logs |
| | | | Temperature logs |

In this example [symbol] AA [symbol] means a [symbol] radiator of a given model [symbol] type, and 0001 is the number of this radiator. Another radiator of the same model would for example have a UID AA0010, and another type of peripheral would have its UID beginning with other characters.

### Method for Installing a Peripheral

According to a second aspect, the invention relates to a method for installing a peripheral 1 in the system described earlier.

Indeed, when a user buys a new peripheral, it is neither known to the Internet access device 2, nor to the peripherals managing equipment 4, and therefore does not have any virtual object 1′.

Thus, this method is triggered during the first connection of the peripheral 1 to an Internet access device 2 and comprises the steps:
identifying the type of peripheral 1,
downloading on the Internet access device 2 a driver associated with the type of peripheral 1, said driver allowing data communications between the Internet access device 2 and the peripheral 1,
creating on the peripherals managing equipment 4 a virtual object 1′ representing in a unique manner the peripheral 1.

The step for identifying the type of peripheral 1 advantageously comprises the qualification of physical operating characteristics of said peripheral 1, and the assignment to the peripheral 1 of a unique identifier according to said physical characteristics. This is applied by the Internet access device 2 which detects a new peripheral 1. The physical characteristics may be quite simply the type of connectivity used by the peripheral and certain data transmitted by default during the connection. The unique identifier (or UID) may, as explained beforehand, comprise a code fragment identifying the type.

The Internet access device 2 then queries the peripherals managing equipment 4. Indeed, in addition to the list of virtual objects, a data base of drivers is advantageously stored on the peripherals managing equipment 4. The driver to be downloaded, i.e. associated with a type of peripheral 1, is then identified from among the drivers according to said unique identifier assigned to the peripheral 1.

The driver consists in a piece of computer code comprising the functions required for communication between the peripheral 1 and the Internet access device. A single driver is most often common to several products of a same brand, a single downloading operation is then sufficient. Once it is downloaded, it is installed on the Internet access device 2 and then instanced with the configuration required for its initialization. It should be noted that at that moment, [symbol] subsystems [symbol] may be found, i.e. sub-portions of a complex peripheral 1 which may be considered as integral peripherals. Identifiers are then generated for each of them.

The virtual object 1′ (or the virtual objects 1′ in the case of subsystems) is then first of all created at the internal memory of the Internet access device 2 according to known data, and then copied on the peripherals managing equipment 4.

The virtual object 1′ as well as its attributes is then accessible from any equipment connected to the Internet 30. It should be noted that unlike the prior art where the central element was the Internet access device 2, in the system according to the invention, if a peripheral 1 is transferred from one Internet access device 2 to another, it is immediately recognized. For example if I have an arbitrary object and a switch connected to an Internet access device 2a and controlled at the peripherals managing equipment 4 so that the switch activates the lamp, and if I go to somebody else with this object (in other words I connect it to a new Internet access device 2b different from the Internet access device 2a to which the switch is always connected), after having downloaded a driver required for driving this object, the new Internet access device 2b again finds its associated virtual object 1′. It changes the MAC address which is supplied in its own address. The switch then always control the object although the latter has been moved, and this without the slightest intervention from the user other than the connecting operation.

### Control Method

According to a third aspect, the invention relates to a method for remotely controlling at least one peripheral 1 in the data management system as mentioned earlier.

This method, applied via terminal 6 connected to Internet 30 (which may be a personal computer, a portable telephone, a tactile tablet, or even the Internet access device 2) comprises steps for:
sending from the terminal 6 a request to the peripherals managing equipment 4, said request designating at least one peripheral 1. This may be for example [symbol] switch off the radiator [symbol] . Indeed it is possible to have a customized client on the terminal 6, this client referencing the peripherals 1 of the user and the actions which he/she may have on them. It is noted that this request may be sent remotely and not only from the house 10. It is sufficient to be able to connect to the peripherals managing equipment 4;
consulting with the peripherals managing equipment 4 at least one virtual object 1′ representing said at least one peripheral 1. This consultation is accomplished by means of the UID of the peripheral 1, optionally already known to the terminal 6 and then supplied in the request. The peripherals managing equipment 4 accesses and optionally modifies the relevant attribute(s) of the virtual object 1′;
transmitting the request to said at least one Internet access device 2, the address of which is associated with said at least one determined virtual object 1′. Thus, the Internet access device, to which the peripheral 1 is connected, is traced;
transmitting the request to said at least one peripheral 1 through said at least one Internet access device 2, so that the peripheral executes the request. It should be noted that the request is advantageously transformed by the Internet access device 2 into instructions which may be understood by the peripheral 1 by means of the downloaded driver.

It is noted that a request sent within the scope of a control method may involve several peripherals 1. It is even possible to contemplate [symbol] scenarii [symbol] applied by applications executed on the terminal 6, these scenarii resulting in the sending at given instants of elaborated requests allowing control of several peripherals 1. For example, a scenario of [symbol] return from work [symbol] may involve switching on the heating and opening the roller shutters every weekday at 6.0 pm.

### Monitoring Method

According to a fourth aspect, the invention proposes [symbol] remote monitoring [symbol] of the connected peripherals, whether this be by the owners of equipment or third parties. This monitoring may range from surveillance of his/her house 10 (leak detection, observation of temperature, or even anti-burglary protection), to large scale energy analysis (surveillance of the electric consumption of a whole population as well as of the time-dependent change thereof in order to allow great actors to design optimum energy policies.

Mention may also be made of the applications in audience and survey of media (study of behaviors by noting the hours of use of various peripherals 1) or in the surveillance of persons in particular the elderly or the disabled (an elderly person tends to use the same peripherals with regularity, the detection of unusual uses may mean a problem).

For this, the invention relates to a method for monitoring at least one peripheral 1 in the described peripheral management system, a terminal 6 being connected to the Internet 30.

The method comprises steps for:
sending from the terminal 6 a request to the peripherals managing equipment 4, said request designating one or several peripherals 1;
consulting with the peripherals managing equipment 4 said at least one virtual object 1′ representing said at least one peripheral 1;
transmitting to the terminal 6 at least one recording associated with at least one virtual object 1′ (according to the contents of the request). For example, if the request concerns the present temperature of a room, the last temperature mentioned in the recording of the temperatures measured by a temperature sensor will be sent back to the peripheral 1.

The peripherals managing equipment may thus be considered as a service platform. It is possible to imagine that applications providing many services are developed by companies, and applied on the peripherals managing equipment 4 if the access provider who manages the operator network 20 validates them.

The access provider has the means for guaranteeing anonymity of the data if required by only allowing transmission of raw recordings without any data such as the MAC address, which would concern the privacy of the user.

It should be noted that the terminal 6 may be the peripherals managing equipment 4, itself, in particular for applying alerts: it may be configured by the user so that it itself emits requests causing events (such as sending of a message to the user, switching off the electrical power supply, or even calling the police or firemen) under given circumstances (surveillance of elderly persons as mentioned earlier, activation of a smoke detector, abnormal electric consumption, etc.).

1. A system for managing a plurality of peripherals (1), each peripheral (1) being connected to an Internet access device (2) and each Internet access device (2) being connected to Internet (30) via an operator network (20), characterized in that it comprises a peripherals managing equipment (4) positioned within the operator network (20), a list of virtual objects (1′) being stored on the peripherals managing equipment (4), each virtual object (1′) representing in a unique manner a peripheral (1).

2. The system according to claim 1, wherein each virtual object (1′) consists in a set of computer data comprising:
a unique identifier of the peripherals (1), by which the virtual object (1′) is referenced on the peripherals management equipment (4),
at least one attribute of the peripheral (1), each attribute identifying a controllable element of the peripheral (1).

3. The system according to claim 2, wherein the whole of the computer data of each virtual object (1′) further comprises an address, notably the MAC address, of the Internet access device (2) to which the peripheral (1) represented by the virtual object (1′) is connected.

4. The system according to one of claims 1 to 3, wherein at least one peripheral (1) is connected to the Internet access device (2) via a dongle (3).

5. The system according to one of claims 1 to 4, wherein at least one peripheral (1) is directly connected to the Internet access device (2) via an Ethernet, USB or Wifi connection.

6. The system according to one of claims 1 to 5, wherein each Internet access device (2) records the uses of the peripherals (1) which are connected to it, the recordings being regularly transmitted to the peripherals managing equipment (4).

7. The system according to claim 6, wherein at least one peripheral (1) comprises a sensor for measuring a physical quantity, said recordings of use of the peripheral (1) comprising the values of the physical quantity measured by said sensor.

8. The system according to one of claims 6 to 7, wherein the whole of the computer data of each virtual object (1′) further comprises recordings relating to the peripherals (1), transmitted to the peripherals managing equipment (4).

9. A method for installing a peripheral (1) in the system according to one of claims 1 to 8, characterized in that upon the first connection of the peripherals (1) to an Internet access device (2), steps are applied for:
identifying the type of the peripheral (1),
downloading on the Internet access device (2) a driver associated with the type of the peripheral (1), said driver allowing data communications between the Internet access device (2) and the peripheral (1),
creating on the peripherals managing equipment (4) a virtual object (1′) representing in a unique manner the peripheral (1).

10. The method according to the preceding claim, wherein the step for identifying the type of the peripheral (1) comprises the qualification of physical operating characteristics of said peripheral (1) and the assignment to the peripheral (1) of a unique identifier according to said physical characteristics.

11. The method according to the preceding claim, wherein said driver associated with the type of peripheral (1) is the driver referenced by a unique identifier assigned to the peripheral (1) in a database of drivers stored on the peripherals managing equipment (4).

12. A method for remotely controlling via a terminal (6) connected to Internet (30), at least one peripheral (1) in a system according to one of claims 3 to 8, characterized in that it comprises steps for:
sending from the terminal (6) a request to the peripherals managing equipment (4), said request designating at least one peripheral (1);
consulting with the peripherals managing equipment (4) at least one virtual object (1′) representing said at least one peripheral (1);
transmitting the request to said at least one Internet access device (2), the address of which is associated with said at least one determined virtual object (1′);
transmitting the request to said at least one peripheral (1) through said at least one Internet access device (2).

13. A method for monitoring at least one peripheral (1) in a system according to one of claims 6 to 8, a terminal (6) being connected to Internet (30) characterized in that it comprises steps for:
sending from a terminal (6) a request to the peripherals managing equipment (4), said request designating one or several peripherals (1);
consulting with the peripherals managing equipment (4) said at least one virtual object (1′) representing said at least one peripheral (1);
transmitting to the terminal (6) at least one recording associated with said at least virtual object (1′).
